(19) United States
(12) Patent Application Publication
(10) Pub. No.: US 2024/0294385 A1
(43) Pub. Date: Sep. 5, 2024

(54) METHOD FOR PRODUCING ACTIVATED CARBON

(71) Applicant: Beyonder AS, Sandnes (NO)

(72) Inventors: Fengliu Lou, Stavanger (NO); Zhixin Yu, Sandnes (NO); Kingsley Azuatalam, Hafrsfjord (NO); Obinna Egwu Eleri, Stavanger (NO); Ana Maria Marques Trindade, Stavanger (NO); Dmytro Drobnyi, Stavanger (NO)

(73) Assignee: Beyonder AS, Sandnes (NO)

(21) Appl. No.: 17/768,123

(22) PCT Filed: Oct. 27, 2020
(86) PCT No.: PCT/NO2020/050264

§ 371 Date: Apr. 11, 2022

(30) Foreign Application Priority Data
Oct. 29, 2019 (NO) 20191296

(51) Int. Cl. C01B 32/342; H01G 11/34; H01G 11/86

(52) U.S. Cl. CPC C01B 32/342; H01G 11/34; H01G 11/86; C01P 2006/40

(57) ABSTRACT

A method is for producing activated carbon. The method has the steps of carbonization of a carbon precursor by a first heat treatment to obtain char; mixing of the char with a chemical agent and a reducing agent to serve as a feedstock mixture; and activation of the feedstock mixture by a second heat treatment, wherein the chemical agent is selected from a group comprising potassium hydroxide, sodium hydroxide, sodium carbonate, potassium carbonate, potassium oxide, and sodium oxide and wherein the reducing agent comprises a metal. An electrode has the activated carbon produced by the method. A supercapacitor has the electrode.

### CROSS-REFERENCE TO RELATED APPLICATIONS

This application is the U.S. national stage application of International Application PCT/NO2020/050264, filed Oct. 27, 2020, which international application was published on May 6, 2021, as International Publication WO 2021/086198 in the English language. The International Application claims priority of Norwegian patent application Ser. No. 20/191,296, filed Oct. 29, 2019. The international application and Norwegian application are both incorporated herein by reference, in entirety.

### FIELD

The invention relates to a method for producing activated carbon, to an electrode comprising the activated carbon produced by the method, and to a supercapacitor comprising the electrode.

### BACKGROUND

Supercapacitors provide a type of energy storage device with advantageous properties as the demand for fast charging and high-power delivery of energy is increasing. Powerintensive operations such as acceleration in electric vehicles and hyper cars, energy capture during regenerative breaking, and high life cycle energy storage options not limited by faradaic reactions are among instances where supercapacitors may be applied.

Supercapacitors, which are also known as ultra-capacitors or double layer capacitors, store charges at the interface between an electrode material and an electrolyte. The extent of charge storage is directly related to the surface area of the electrodes, which are typically fabricated from materials such as graphene/graphite, carbon nanotubes, carbon aerogels, and activated carbon, in combination with a suitable binder and, optionally, an additive agent. The supercapacitor typically comprises 2 symmetrical porous electrodes isolated from each other by a separator. A suitable electrolyte and separator are added between the electrodes, where the separator allows for flow of ionic currents between the electrodes. A current collector, for example comprising aluminium is also attached to the electrodes to ensure electrical contact and decrease the internal resistance in the cell.

The physical process of charge storage in a supercapacitor, which contrasts the chemical reactions involved in batteries, makes it much easier to give out stored charges. Supercapacitors can therefore be charged and discharged easily since the physical process of energy storage is reversible. This process is also responsible for the large cycle life and high-power densities of the supercapacitor. Supercapacitors can therefore deliver high power when required, while also possessing fast charge and discharge capabilities. This is in contrast with batteries, which are limited by chemical reactions required to take place, and the latency associated with conversion of chemical energy to electrical energy. By virtue of this, batteries can store a large amount of energy, but can only deliver at very slow rates, i.e. they have a high specific energy but low specific power. Supercapacitors, on the other hand, can deliver all the energy stored almost at an instant. They are therefore referred to as possessing high power. Despite this, they are plagued by the small amount of specific energy they can store. It is proposed that if the specific energy of supercapacitors could be increased while at the same time the high specific power, long cycle life, and fast charge and discharge time is maintained, supercapacitors would be able to compete favourably against and possibly replace the use of batteries in powerintensive operations.

Increasing the specific energy of the supercapacitor can for example be achieved by increasing its specific capacitance or by increasing its operating voltage, which are both functions of the specific energy. Many options have been investigated towards increasing the specific capacitance of supercapacitors, and this has been mostly related to the different electrode materials used in its assembly. Electrode materials such as graphene/graphite, carbon aerogels, carbon nanotubes, and activated carbon have all been used with varying degree of success. Different criteria are required prior to their utilization, including excellent conductivity, high specific surface area, existence of optimized balance of micro- and mesopores, high chemical and thermal stability, optimum pore volumes, and desired surface chemical compositions. These properties have all been optimized in various research towards increasing the specific capacitance of the supercapacitor.

The carbon precursor for the electrode material also plays an important role in the determination of these properties. Based on this fact, activated carbon has been a widely considered option as evidenced by the abundance of readily available materials which could be used in its fabrication. These materials are typically from different forms of biomass and other lignin-rich sources. The production of activated carbon has even been promoted as an efficient technique for conversion of waste biomass into valuable products.

Increasing the specific energy of the supercapacitor by increasing the operating voltage window is hugely dependent on the nature of the electrode material and electrolyte used.

Electrolytes can either be aqueous, organic, or ionic electrolytes, sometimes in combination with different solvents. Aqueous electrolytes are cleaner and environmentally safe options with additional advantages such as high conductivity, but they are limited to an operating voltage window of 1-2 V due to the decomposition potential of water. Organic electrolytes are today mostly used in commercial supercapacitors with the potential of reaching up to 3 V in combination with various solvent such as propylene carbonate (PC) or acetonitrile, but their toxic nature has plagued their utilization in certain applications. Ionic electrolytes can reach up to 4 V and do not require solvents, but they are limited in terms of operating temperatures and conditions before their utilization. Different studies have been published relating to determination of efficient supercapacitor electrolytes that could withstand high voltage ranges in order to maximize the specific energy of the supercapacitor. Notable methods include the use of ionic electrolytes, combination of solvents such as PC and acetonitrile in organic electrolytes, optimization of pH in aqueous electrolytes to extend the operating voltage etc.

Optimization of the electrode material and its properties can also contribute to increase the specific energy of supercapacitors. Different methods to increase the specific energy of the supercapacitor have been studied, for example introduction of surface function groups, utilization of different materials such as graphene/graphite with high conductivities, carbon aerogels with modified surface functional groups, carbon cloths and fibres with high surface area, and metal oxide electrodes with faradic capacitive behaviour.

Activated carbon is seen as a good choice as electrode material for supercapacitors, since it is conductive and has a large surface to volume ratio due to its porous structure. Activation of the carbon precursor may either be performed via physical or chemical means. Physical activation typically involves the pyrolysis of the carbon precursor in an inert atmosphere to remove the volatile matter present, and then proceeded by gasification in the presence of a suitable gasification agent such as steam, ammonia, oxygen, or carbon dioxide at very high temperatures. Chemical activation typically involves mixing of a chemical agent with a carbon precursor in addition to heat treatment under an inert atmosphere. Alkali metal compounds, zinc chloride, and phosphoric acid are some of the chemical agents reported to have been used in chemical activation. Porosity is formed via reactions of the oxidizing agent with the reactive carbon present in the material, which leads to the formation of carbon oxides and variable burn-offs. Some advantages of chemical activation compared to physical activation include higher carbon yield, lower activation temperature required, higher surface area, and well developed and narrow micro porosity.

An etching process occurring during physical and chemical activation of the carbon precursors is largely responsible for the generation and widening of existing pores in activated carbon. However, this process occurs with a significant number of defects introduced in the structure of the activated carbon which hinders its electrochemical performance when used as electrodes in a supercapacitor assembly. Reduced electrical conductivity, increased electrolyte decomposition, and subsequent narrowing of the operating voltage window are some of the disadvantages felt on the assembled supercapacitors.

The nature of these defects in activated carbon can also be linked to the effects of defects observed in graphene structures which affect their electrochemical performance, especially their conductivity. X-ray diffraction spectra obtained from the analysis of activated carbon samples show the onset of graphitization with reflections of (002) and (100) observed at 2θ values of 26° and 42°. This has been reported to be responsible for the conductive behaviour of activated carbon although with the significant peak broadening observed in the spectra indicating that a large portion of the activated carbon was amorphous. The other part which contained significant amounts of graphene was to a large extent responsible for its electrical conductivity and other desirable electrochemical performance-related properties. However, the graphene formed was prone to possess defects.

Sanchez-Gonzalez et al. (Journal of Electroanalytical Chemistry, 2011. 657(1-2): 176-180) investigated the role of electrical conductivity of carbon in the electrochemical capacity performance. Postulations were made that the conductivity of activated carbon is seen to increase upon heat treatment above 700° C. This temperature also corresponds with the onset of graphitization in activated carbon. A link could be established that the increase in conductivity of the activated carbon is brought about by the onset of graphitization beginning at 700° C.

U.S. Pat. No. 20,090,80142 A1 discloses a process of making activated carbon.

### SUMMARY

The invention has for its object to remedy or to reduce at least one of the drawbacks of the prior art, or at least provide a useful alternative to prior art. The object is achieved through features, which are specified in the description below and in the claims that follow.

The invention is defined by the independent patent claim, while the dependent claims define advantageous embodiments of the invention.

In a first aspect, the invention relates to a method for producing activated carbon, wherein the method comprises the steps of
carbonization of a carbon precursor by a first heat treatment to obtain char;
mixing of the char with a chemical agent and a reducing agent to serve as a feedstock mixture; and
activation of the feedstock mixture by a second heat treatment,
   wherein the chemical agent is selected from a group comprising potassium hydroxide, sodium hydroxide, sodium carbonate, potassium carbonate, potassium oxide, and sodium oxide, and wherein the reducing agent comprises a metal. The reducing agent captures oxidizing chemical species which results from decomposition of the chemical agent.

The chemical agent has two main effects in this method. One effect is etching, wherein the chemical agent, or reaction products from chemical reactions of the chemical agent, reacts with carbon, which creates porosity in the produced activated carbon. The reaction of the chemical agent with carbon generally includes oxidation, so oxygen in the compounds is beneficial. Some etching is needed in the production of activated carbon with a desired distribution of pores, however, too much etching may cause the pores to become too large, whereby the total surface area of the activated carbon is decreased. This is disadvantageous for most applications, since activated carbon is typically used due to its large surface area. Additionally, etching introduces a high number of defects.

The second effect of the chemical agent is intercalation of its metal part, i.e. sodium or potassium, into carbon layers of the activated carbon. Such intercalation weakens the interaction between the layers and leads to increased exfoliation, thereby providing a better surface. The metal part of the chemical agent therefore provides an advantage.

The reducing agent is added to capture the oxidizing chemical species, for example O₂ and H₂O depending on the chemical agent. The capture of the oxidizing chemical species thereby prevents or decreases oxidation of carbon to decrease etching, and additionally prevents or decreases oxidation of the metal part of the chemical agent to maintain the degree of intercalation. Effect of mixing the reducing agent and the chemical agent is therefore that the exfoliation process of the carbon sheet occurs at a higher rate, and that the number of defects is reduced. The method therefore results in activated carbon which has a low number of defects, high electrical conductivities, and a high surface area with significant micropore and mesopore content compared to the prior art. The surface area of the activated carbon can be more than 3000 m²/g, which may be advantageous for many applications, e.g. electrochemical energy storage.

The carbon precursor maybe be from different biomass sources such as pine wood saw dust, coconut shell, waste papers or from synthetic polymer materials such as phenolic resins, polyvinyl alcohol, rubber and polyacrylonitrile. The carbon precursor used significantly affects the characteristics of the activated carbon with very large influence on the nature of the formed pores, porosity development, specific surface area, electrical conductivity, and surface chemical composition. Selection of a suitable precursor is vital for each application based on the specific requirements of the activated carbon needed.

The method may additionally comprise the step of washing the activated carbon to ensure removal of the reducing agent, the chemical agent, and any other side products which may have formed during the process. Washing may be carried out with an alkaline solution, e.g. KOH or NaOH, followed by rinsing with hot water, and/or washing with suitable acid solutions such as HCl and/or nitric acid. The concentrations of the alkaline and acid solutions may typically be 0.1-10 M. Chemical agents as well as wastewater from the washing step may be recycled to reduce wastage and process cost.

The reducing agent comprises a metal, for example Al, Cu, or Mg, since metals in single form are some of the strongest reducing agents available. They also have the benefit that no additional chemicals are introduced which could cause undesired properties in the activated species. Al and Cu may be particularly advantageous, since these are readily available and cheap, and less stringent requirements are needed before their use. Mg is very reactive, so more planning is required for using Mg in its pure metal form.

The chemical agent may comprise KOH, which may be particularly advantageous because of the nature of the diameters of the micropore formed. The micropore diameters of activated carbon are desired to have a narrow distribution, typically around 0.8-1.0 nm, which may be obtained using KOH as a chemical agent. Use of e.g. NaOH will also activate the carbon precursor, but it will result in a wider size distribution including pore sizes which does not contribute to improving the properties of the activated carbon. The nature of the carbon precursor used also influences the choice of chemical agent. Most precursors are readily activated with KOH and produce good results with suitable porosity, while the use of NaOH works effectively with fewer types of carbon precursor.

Either of the carbonization step or the activation step may be carried out under an atmosphere of an inert gas.

The first heat treatment in the carbonization step may carried out at a temperature ranging from 400-600° C. This may for example be performed in a tube furnace for 0.5-2 hours, for example under an atmosphere of an inert gas. The carbonization step is included to obtain char which is more effective upon contact with the chemical agent than the carbon precursor directly. Thereafter, the char obtained is then mixed with the chemical agent and metal additive in various ratios, aided by crushing to obtain the feed stock for activation.

Impregnation ratios of char to chemical agent may typically range from 1:10 to 100:1, for example 1:1, 1:2, 1:4, 1:100, 2:1, or 4:1. The reducing agent may be mixed with the char and the chemical agent a ratio ranging from 0.01 to 10, i.e. a ratio of char to reducing agent to chemical agent of 1-10:0.1-10:1-1000, for example 1:0.1:4, 1:0.25:4, 1:0.5:4, 1:1:4, 1:2:4, or 1:0.2:2.

The second heat treatment in the activation step may carried out at a temperature ranging from 600-1000° C., for example 600, 700, 750, 800, 850, or 900° C. The decomposition of the chemical agent depends on the temperature, so at temperatures around 700° C. and above the chemical agent is very effect. Temperatures above 1000° C. may be disadvantageous due to e.g. unwanted side reactions and high energy use. The heating rate may be 2-1000° C./min, e.g. 2, 4, 5, 6, 10, 20, or 1000° C./min. The activation time may typically be between 0.1 and 72 hours, for example 0.1, 0.2, 0.3, 1, 2, or 3 hours, but it may also be longer. After the activation, the product may be allowed to cool at a cooling rate between 1 and 300° C./min, e.g. 1, 2, 4, 6, 7 or 10° C./min.

The optimum chemical agent/reducing agent ratio, temperature, and concentration for producing activated carbon for a desired application may be obtained by varying these parameters.

Activated carbon produced by the method according to the invention may have high specific surface, e.g. 3350 m²/g, narrow micropore size distribution, significant mesopore content, and relatively high degree of purity. These characteristics provide excellent performance when utilized as electrode materials for supercapacitors and storage media for compressed adsorbed natural gas. The possibility of tuning the properties, especially the pore size distribution, exists, which further aids in the desired application, for example as electrodes for supercapacitors. However, an addition of an excessive amount of reducing agent, e.g. metal, may influence specific surface area. For example, sintering of metal particles may occur at high temperatures, especially at high metal concentrations. Such sintering at high metal concentrations may hinder the gasification of the carbon at high temperatures as the carbon surface is protected by the sintered metal. It may also cause difficulty of removing the metal additive, which may require increased washing and/or increased washing agent concentration, which in addition may lead to additional process cost with little benefits. The optimum amount of reducing agent may be therefore be a concentration which influences the activation by promoting exfoliation and decreasing etching, thereby resulting in activated carbon with very high yields which has a high surface area compared to activated carbon prepared with similar conditions but without the reducing agent. The above-mentioned properties may guide the selection of the optimum amount of reducing agent. It may for example be evaluated based on the possibility of obtaining excellent electrochemical performance, and not based on the obtained surface area alone.

In a second aspect, the invention relates to an electrode comprising the activated carbon produced by the method according to the first aspect of the invention. The low level of defects in the activated carbon causes it to have a high electrical conductivity, which is advantageous when the activated carbon species is used in an electrode.

In a third aspect, the invention relates to a supercapacitor comprising the electrode according to the second aspect of the invention. The use of activated carbon in a supercapacitor electrode is advantageous because properties such as pore size, pore volumes, and surface functional groups may be relatively easily tuned to impact certain desirable properties. Additionally, as defects in activated carbon used in a supercapacitor catalyse the electrolyte decomposition at high voltages, reduction of the amount of these defects therefore increases the operating voltage window of the supercapacitor and maximizes the full potential of the electrolyte.

An indicator of reduced defects is the increase of the conductivity of the activated carbon portrayed by decreasing resistance. This decreased resistance may additionally contribute to an increase in the specific power of the supercapacitor, as the resistance of the electrode is one of the factors which affects the specific power.

The properties of the supercapacitor have been confirmed by analyses such as ohmic resistance, coulombic efficiency values from galvanostatic charge and discharge at high temperatures, and cyclic voltammetry.

For example, when an activated carbon species with specific capacitance of 160 F/g which was produced by the method according to the invention (hereafter referred to as non-destructively activated sample and abbreviated NDA sample) was compared with a sample produced under similar conditions but without the reducing agent (referred to herein as a blank sample), the Ohmic resistance of the NDA sample was 35% lower than that of the blank sample. This indicates that an improvement of the electrical conductivity occurred upon introduction of the reducing agent in the activation process. Ash content analysis showed, with results in the range of 0-2%, that the chemical agent and the reducing agent could be effectively removed by a subsequent washing step. This ensured that the chemical and reducing agent did not influence the results of the different characterizations. XRD analysis also confirmed that the chemical and reducing agents were eliminated by the washing process. Thus, it could be concluded that only the structure of the activated carbon was affected via a reduction in the level of defects following the metal intercalation and subsequent exfoliation.

Galvanostatic charge and discharge experiments carried out on supercapacitors fabricated with electrodes from an NDA sample and a blank sample with a voltage range up to 3 V showed that the NDA samples performed best, with a coulombic efficiency of 97.8% after a large number of cycles at the highest voltage.

Cyclic voltammetry carried out on supercapacitors manufactured with electrodes from an NDA sample and a blank sample to investigate the operating voltage window at different voltage ranges showed that the NDA samples performed at a maximum window from 0-3.25 V without oxidation occurring. Thus, the voltage window of the supercapacitor was extended beyond that of the blank which began to show oxidation peaks at voltage window from 0-3 V.

### BRIEF DESCRIPTION OF THE DRAWINGS

In the following is described examples of embodiments of the invention. Some results are illustrated in the accompanying drawings, wherein:

FIG. 1 Shows the size distribution of an NDA sample;

FIG. 2 Shows the cyclic voltammogram of an NDA sample with Al at a voltage window of 0-3.25 V and scan rate of 20 mv/s;

FIG. 3. Shows the cyclic voltammogram of an NDA sample with Cu at a voltage window of 0-3.25 V and scan rate of 20 mv/s; and

FIG. 4. Shows the plot of coulombic efficiencies at different voltages for an NDA sample and a blank sample.

### DETAILED DESCRIPTION OF THE DRAWINGS

In the below examples, the char was prepared by carbonizing an amount of pine wood saw dust at temperatures between 400-600° C. in a tube furnace under nitrogen gas atmosphere to obtain char for the subsequent activation process.

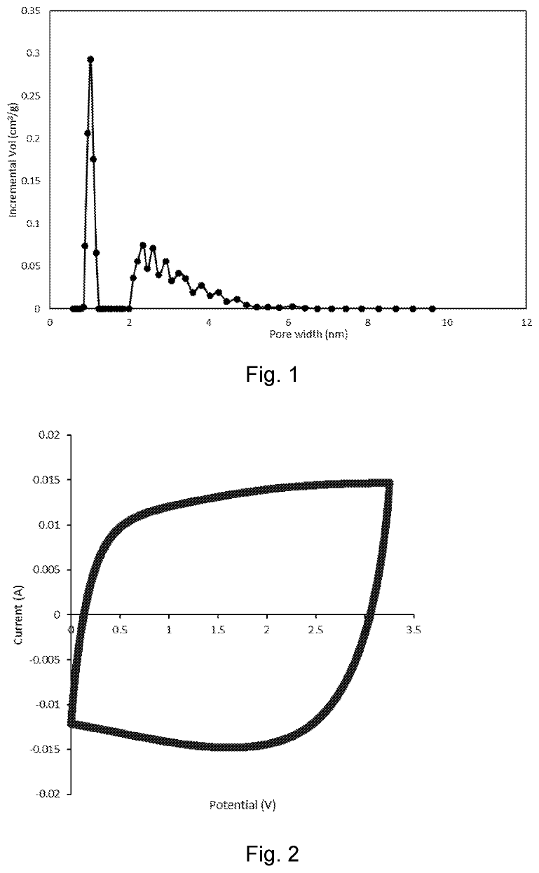

In Example 1, produced char is mixed with KOH pellets and Al metal in powdered form in the ratio 1:0.25:4 of char to Al to KOH. Mixing is aided by homogenous grinding and crushing of the pellets in a crucible. The mixture is introduced into a tube furnace and heated to 850° C. at a heating rate of 10° C./min and residence time of 2 hours under a nitrogen gas atmosphere. The tube is thereafter cooled down to ambient temperature and the activated carbon is washed with 1 M KOH and hot water followed subsequently by washing with 1 M HCl and hot water before drying in an oven. The obtained activated carbon had very high surface area (>2900 m²/g), narrow micropore size distribution, and significant mesopore content as seen in FIG. 1. A dual electrode symmetric supercapacitor fabricated using this activated carbon as electrode material and TEABF4 electrolyte shows a high specific capacitance >150 F/g. Ohmic resistance conducted on the electrode is 0.135 Ω.cm2 which is lower than those obtained from electrodes fabricated with blank samples (without the Al additive). Cyclic Voltammetry conducted on coin cells produced using electrodes made with the samples shows an operating voltage windows of 0-3.25 V, as shown in FIG. 2, which is higher than blank samples (not shown).

In Example 2, produced char is mixed with KOH pellets and Al metal in powdered form in the ratio 1:0.5:4 of char to Al to KOH. Mixing is aided by homogenous grinding and crushing of the pellets in a crucible. The feedstock mixture is introduced into the tube furnace and heated to 850° C. at a heating rate of 10° C./min and residence time of 2 hours under a nitrogen gas atmosphere. The tube is thereafter cooled down to ambient temperature and the activated carbon is washed with 1 M KOH and hot water followed subsequently by washing with 1 M HCl and hot water before drying in an oven. The obtained activated carbon had very high surface area (>2700 m²/g), narrow micropore size distribution, and significant mesopore content.

In Example 3, produced char is mixed with KOH pellets and Al metal in powdered form in the ratio 1:0.25:4 of char to Al to KOH. Mixing is aided by homogenous grinding and crushing of the pellets in a crucible. The feedstock mixture is introduced into the tube furnace and heated to 750° C. at a heating rate of 10° C./min and residence time of 2 hours under a nitrogen gas atmosphere. The tube is thereafter cooled down to ambient temperature and the activated carbon is washed with 1 M KOH and hot water followed subsequently by washing with 1 M HCl and hot water before drying in an oven. The obtained activated carbon has very high surface area (>2600 m²/g), narrow micropore size distribution, and significant mesopore content.

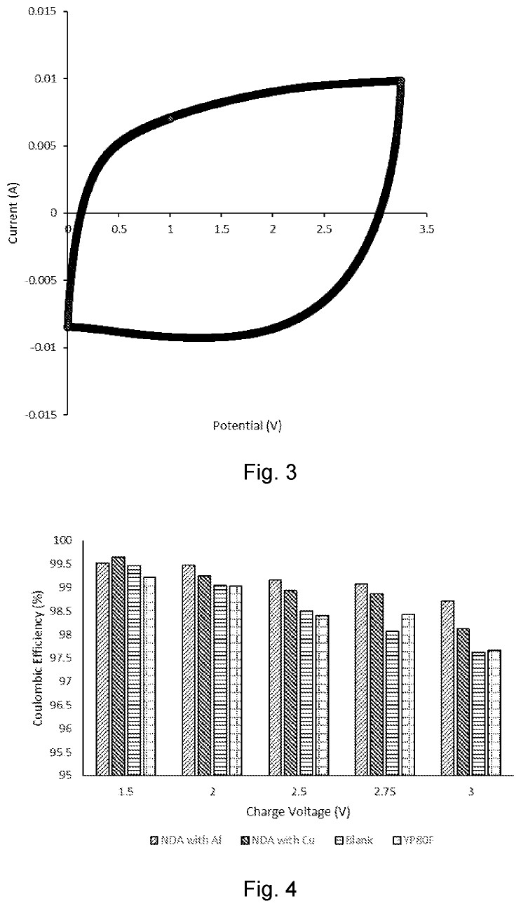

In Example 4, produced char is mixed with KOH pellets and Cu metal in powdered form in the ratio 1:0.25:4 of char to Cu to KOH. Mixing is aided by homogenous grinding and crushing of the pellets in a crucible. The feedstock mixture is introduced into the tube furnace and heated to 850° C. at a heating rate of 10° C./min and residence time of 2 hours under a nitrogen gas atmosphere. The tube is thereafter cooled down to ambient temperature and the activated carbon is washed with 1 M KOH and hot water followed subsequently by washing with 1 M HCl and hot water before drying in an oven. The obtained activated carbon has very high surface area (>2900 m²/g), narrow micropore size distribution and significant mesopore content. Ohmic resistance conducted on the electrode is 0.18 Ω.cm2 which is lower than those obtained from electrodes fabricated with blank samples (without the Al additive). Cyclic Voltammetry conducted on coin cells produced using electrodes made with the samples had operating voltage windows of 0-3.25 V, as shown in FIG. 3, which is higher than the blank samples.

In Example 5, produced char is mixed with KOH pellets and Cu metal in powdered form in the ratio 1:0.5:4 of char to Cu to KOH. Mixing is aided by homogenous grinding and crushing of the pellets in a crucible. The feedstock mixture is introduced into the tube furnace and heated to 850° C. at a heating rate of 10° C./min and residence time of 2 hours under a nitrogen gas atmosphere. The tube is thereafter cooled down to ambient temperature and the activated carbon is washed with 1 M KOH and Hot water followed subsequently by washing with 1 M HCl and hot water before drying in an oven. The obtained activated carbon had very high surface area (>2900 m²/g), narrow micropore size distribution, and significant mesopore content.

In Example 6, produced char is mixed with KOH pellets and Cu metal in powdered form in the ratio 1:0.25:4 of Char to Cu to KOH. Mixing is aided by homogenous grinding and crushing of the pellets in a crucible. The feedstock mixture is introduced into the tube furnace and heated to 750° C. at a heating rate of 10° C./min and residence time of 2 hours under a nitrogen gas atmosphere. The tube is thereafter cooled down to ambient temperature and the activated carbon is washed with 1 M KOH and hot water followed subsequently by washing with 1 M HCl and hot water before drying in an oven. The obtained activated carbon had very high surface area (>2500 m²/g), narrow micropore size distribution, and significant mesopore content.

In Example 7, produced char is mixed with KOH pellets and Cu metal in powdered form in the ratio 1:0.5:4 of char to Cu to KOH. Mixing is aided by homogenous grinding and crushing of the pellets in a crucible. The feedstock mixture is introduced into the tube furnace and heated to 750° C. at a heating rate of 10° C./min and residence time of 2 hours under a nitrogen gas atmosphere. The tube is thereafter cooled down to ambient temperature and the activated carbon is washed with 1 M KOH and Hot water followed subsequently by washing with 1 M HCl and hot water before drying in an oven. The obtained activated carbon had very high surface area (>3300 m²/g), narrow micropore size distribution, and significant mesopore content.

In Example 8, produced char is mixed with KOH pellets and Cu metal in powdered form in the ratio 1:1:4 of char to Cu to KOH. Mixing is aided by homogenous grinding and crushing of the pellets in a crucible. The feedstock mixture is introduced into the tube furnace and heated to 850° C. at a heating rate of 10° C./min and residence time of 2 hours under a nitrogen gas atmosphere. The tube is thereafter cooled down to ambient temperature and the activated carbon is washed with 1 M KOH and hot water followed subsequently by washing with 1 M HCl and hot water before drying in an oven. The obtained activated carbon had very high surface area (>3200 m²/g), narrow micropore size distribution, and significant mesopore content.

In Example 9, the activated carbon produced via the method and ratios discussed in this application is used to fabricate an electrode. The electrode is fabricated by a combination of the activated carbon, with or without carbon black as conductive agent, and polytetrafluoroethylene (PTFE) as binder. A powder mixture consisting of 85-92 wt % activated carbon, 8-15 wt % PTFE is turned into dough, rolled and pressed to form an activated carbon electrode with a thickness 50-100 μm. The fabricated electrode and an organic electrolyte are used to assemble a supercapacitor.

In Example 10, the activated carbon electrode was used to assemble supercapacitors in form of coin cells. Galvanostatic charge and discharge electrochemical analysis was performed on the cells, comparing the NDA with Al, NDA with Cu and the blank samples. The coulombic efficiency obtained is show in FIG. 4. The NDA with Al exhibited the highest coulombic efficiency of 98.71% at 3 V, NDA with Cu coming next with 98.12% and the blank sample with coulombic efficiency of 97.63%. This shows the superior stability of the NDA with Al samples in comparison with the blank sample. Similar analysis was carried out on a commercial activated carbon sample YP80F, where a coulombic efficiency of 97.67% was obtained. The electrodes were fabricated with the same ratio of binder, similar current collectors, and similar electrode thickness.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A method for producing activated carbon, wherein the method comprises the steps of:
carbonization of a carbon precursor by a first heat treatment to obtain char;
mixing of the char with a chemical agent and a reducing agent to serve as a feedstock mixture; and
activation of the feedstock mixture by a second heat treatment to produce activated carbon,
wherein the chemical agent is selected from a group comprising potassium hydroxide, sodium hydroxide, sodium carbonate, potassium carbonate, potassium oxide, and sodium oxide, and
wherein the reducing agent comprises a metal.

2. The method according to claim 1, wherein the method additionally comprises the step of washing the activated carbon.

3. The method according to claim 1, wherein the metal is selected from a group consisting of Al and Cu.

4. The method according to claim 1, wherein the chemical agent comprises KOH.

5. The method according to claim 1, wherein either of the carbonization step or the activation step is carried out under an atmosphere of an inert gas.

6. The method according to claim 1, wherein the first heat treatment in the carbonization step is carried out at a temperature ranging from 400-600° C.

7. The method according to claim 1, wherein the second heat treatment in the activation step is carried out at a temperature ranging from 600-1000° C.

8. An electrode comprising the activated carbon obtained by the method according to claim 1.

9. A supercapacitor comprising the electrode according to claim 8.

10. The method according to claim 2, wherein the metal is selected from a group consisting of Al and Cu.

11. The method according to claim 2, wherein the chemical agent comprises KOH.

12. The method according to claim 3, wherein the chemical agent comprises KOH.

13. The method according to claim 2, wherein either of the carbonization step or the activation step is carried out under an atmosphere of an inert gas.

14. The method according to claim 3, wherein either of the carbonization step or the activation step is carried out under an atmosphere of an inert gas.

15. The method according to claim 4, wherein either of the carbonization step or the activation step is carried out under an atmosphere of an inert gas.

16. The method according to claim 2, wherein the first heat treatment in the carbonization step is carried out at a temperature ranging from 400-600° C.

17. The method according to claim 3, wherein the first heat treatment in the carbonization step is carried out at a temperature ranging from 400-600° C.

18. The method according to claim 4, wherein the first heat treatment in the carbonization step is carried out at a temperature ranging from 400-600° C.

19. The method according to claim 5, wherein the first heat treatment in the carbonization step is carried out at a temperature ranging from 400-600° C.
